(19) United States
(12) Patent Application Publication
(10) Pub. No.: US 2021/0170294 A1
(43) Pub. Date: Jun. 10, 2021

(54) SYSTEM, METHOD, AND DEVICE FOR MOLDING A MODELING COMPOUND

(71) Applicant: CRAYOLA LLC, Easton, PA (US)

(72) Inventors: Robert J. Henry, Bethlehem, PA (US); Joseph Thomas Moll, Bethlehem, PA (US); James William Allen, Nazareth, PA (US); Albert P. Mauro, JR., Kansas City, MO (US); David J. Catanzaro, Carbondale, PA (US); Richard Swika, Peckville, PA (US)

(21) Appl. No.: 17/165,395

(22) Filed: Feb. 2, 2021

Related U.S. Application Data
(62) Division of application No. 16/277,247, filed on Feb. 15, 2019.
(60) Provisional application No. 62/710,425, filed on Feb. 16, 2018.

(51) Int. Cl. A63H 33/00; B29C 39/02; B29C 39/36; B29C 39/26; A63H 3/36

(52) U.S. Cl. CPC A63H 33/001; B29C 39/026; B29L 2031/529; B29C 39/26; A63H 3/365; B29C 39/36

(57) ABSTRACT

Embodiments of the invention are directed to a molding system and kit for molding a modeling compound. The molding system is generally comprised of an openable interlocking molding device, the openable interlocking molding device is configured to cast external features onto a modeling compound surface by securing the modeling compound within a molding cavity of the openable interlocking molding device. Further, the molding system includes a substrate with movable joints that is configured to be enveloped by the modeling compound prior to casting the external features onto the modeling compound by the interlocking molding device.

### CROSS-REFERENCE TO RELATED APPLICATIONS

This is a Divisional Application of U.S. Non-Provisional application Ser. No. 16/277,247, filed on Feb. 15, 2019, and entitled “System, Method, And Device for Molding A Modeling Compound,” which claims priority to U.S. Provisional Application Ser. No. 62/710,425, filed on Feb. 16, 2018, and entitled “System, Method, And Device for Putty Composition Molding,” the entireties of which are herein incorporated by reference.

### SUMMARY

Embodiments of the invention are defined by the claims below, not this summary. A high-level overview of various aspects of the invention disclosure introduces a selection of concepts that are further described below in the detailed description. This summary is not intended to identify key features or essential features of the claimed subject matter, nor is it intended to be used as an aid in isolation to determine the scope of the claimed subject matter.

In brief and at a high level, this disclosure describes, among other things, a system, a method, and a device for molding modeling compound compositions such as, for example, silicone-based modeling compounds or any compound suitable for molding within the openable interlocking molding device described herein.

### DESCRIPTION OF THE DRAWINGS

Illustrative embodiments of the invention are described in detail below with reference to the attached drawing figures, and wherein:

FIG. 1A depicts an exemplary molded article on a digit of a hand of a user, and corresponding components of an openable interlocking molding device, in accordance with aspects herein;

FIG. 1B depicts the exemplary molded article shown in FIG. 1A on a different substrate;

FIG. 2A-2F depict the exemplary mold components and how they are fitted together to form the openable interlocking molding device, in accordance with aspects herein;

FIG. 3A-3G illustrates a series of steps demonstrating how the openable interlocking molding device in accordance with aspects herein is used;

FIGS. 4A and 4B depict different exemplary molded modeling compounds, in accordance with aspects herein;

FIG. 5 depicts an exemplary openable interlocking molding device kit, showing two different molds and two pieces of modeling compound;

FIGS. 6A-6F depict how exemplary mold assembly structures in, for example, the kit depicted in FIG. 5 can be interchangeably assembled, in accordance with aspects herein;

FIG. 7A-7C depicts a molded modeling compound molded according to FIGS. 6A-6F the assembly of interchangeable mold assembly structures with a first exemplary type of capping structure;

FIG. 8A-8C depicts a different exemplary molded modeling compound molded by assembling a first molding component of a first openable interlocking molding device with a second molding component of a second openable interlocking molding device, in accordance with aspects herein;

FIG. 9 depicts an alternative capping component for the openable interlocking molding device, in accordance with aspects herein;

FIGS. 10A-10D depict an exemplary substrate structure that may be used with an exemplary openable interlocking molding device, in accordance with aspects herein;

FIG. 11A-11E depicts a different exemplary substrate structure that may be used with the openable interlocking molding device, in accordance with aspects herein;

FIG. 12 depicts how portions of substrates may be interchangeable, in accordance with aspects herein;

FIGS. 13A-13B depict yet another different exemplary substrate structure that may be used with the openable interlocking molding device to add an element of surprise, in accordance with aspects herein;

FIG. 14 depicts an exemplary substrate structure with movable joints, in accordance with aspects herein;

FIGS. 15A-15C depict an exemplary movable joint structure;

FIGS. 16A and 16B depict a figurine comprised of a modeling compound molded onto the exemplary substrate structure shown in FIG. 14;

FIGS. 17A and 17B depict an exemplary substrate structure with movable joints; and

FIGS. 18A and 18B depict an exemplary substrate structure with movable joint in varying positions.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In accordance with aspects herein, a molding, embossing, and/or casting system for applying an external surface feature to a quantity of a modeling compound is described. Examples of molded modeling compound articles and corresponding mold structures are provided. In these examples, a mold structure for receiving a quantity of modeling compound may include a molding cavity having an internal volume corresponding to a volume of modeling compound provided with the molding system. In these examples, an openable interlocking molding device may be provided, where the openable interlocking molding device may be comprised of a first molding component and a second molding component that are complementary with or correspond to one another, such that together, they create a molding cavity useful for creating a three-dimensional molded article from a modeling compound. For example, the first molding component may comprise a first concave surface with a first plurality of ridges and valleys on the first concave surface. Similarly, the second molding component may comprise a second concave surface with a second plurality of ridges and valleys on the second concave surface. When assembled, the outer edge of the first concave surface of the first molding component may be configured to directly face, or be in a parallel plane with, the outer edge of the second concave surface of the second molding component such that the molding cavity is formed.

For example, the first molding component may be a mold front for molding embossing characteristics onto a first (front side) portion of a modeling compound, and the second molding component may be a mold back for molding and/or embossing characteristics to a second (back side) portion of the modeling compound, thereby forming a complete three-dimensional molded article or structure (e.g., a figurine, head, 3-D character, or the like). For example, the molding device may be configured for molding the surface characteristics onto a surface of a modeling compound to resemble, for example, a skull, where the first molding component would impart embossing characteristics of a skull to a front side of the modeling compound and the second molding component would impart embossing characteristics of the skull to a back side of the modeling compound, resulting in a three dimensional (3D) representation of the skull made of the modeling compound.

In further aspects, a standalone surface molding component may be a mold from for molding and/or embossing characteristics onto a first surface of a modeling compound. In this example, the standalone surface molding component may be used to impart embossing characteristics to a single or multiple different portions of a modeling compound, with or without a supplemental mold “back” to correspond with the mold front. In other words, a modeling compound may be applied to a base substrate surface having a desired three-dimensional structure. Once the base substrate's surface is covered with modeling compound, the standalone surface molding component may be applied to one or more portions of the covering of modeling compound, similar to the application of an embossed texture to a moldable surface. For example, in one aspect, a dinosaur mold substrate having a three-dimensional structure may be covered in a modeling compound, and subsequently treated with incremental applications of surface embossing by a mold structure configured to impart surface features of the dinosaur. In some aspects, a particular surface casting mold may correspond to a particular portion of the underlying substrate base, such as a surface mold configured to mate to at least a portion of the foot and/or leg of an underlying dinosaur mold, while a second casting mold structure may be configured to correspond to a different portion of the underlying substrate base, such as a surface mold configured to mate to at least a portion of the neck and/or head, applying the relative features for different portions of the underlying substrate. Accordingly, a first surface mold may include a single mold structure with a concave molding surface (e.g., molding dinosaur scales onto a first portion of a modeling compound-covered dinosaur substrate) giving a particular embossed appearance to the contacted modeling compound, whether or not the first surface mold's concave molding surface is mated to a supplemental mold structure to emboss further surfaces of the three-dimensional structure. As such, the mold structure may include multiple molded structures with concave molding surfaces, that couple together to impart surface molded features to multiple surfaces of the underlying substrate (e.g., both the front side of the dinosaur leg and the back side of the dinosaur leg, imparted with embossed features from two separate, interlocking molds).

In some aspects, the openable interlocking molding device includes a coupling mechanism on the first and second molding components. The coupling mechanism is generally configured to secure the first molding component and the second molding component to each other so that the first molding component and the second molding component are relatively immobilized relative to each other when the openable interlocking molding device is assembled and ready to receive the modeling compound. For example, the mold front may have an outer edge feature corresponding to an outer edge feature on the mold back, such that a mold front portion may couple to the mold back portion while a user secures a quantity of modeling compound and/or putty inside the mold. In further aspects, the internal volume of the mold, and surrounding surfaces of the interior molded characteristics, may correspond to an approximate volume of a single segment of a putty compound. In another aspect, the internal volume of the mold, and surrounding surfaces of the interior molded characteristics, may correspond to an approximate total volume of a single segment of putty compound with an additional, underlying substrate such as a pen, toy, a user's finger and/or thumb, and the like. For example, a particular volume of modeling compound, such as SILLY PUTTY®, available from Crayola LLC, Easton, Pa., may fit within the total mold volume when both the front and back mold portions are coupled together. In further aspects, a particular volume of modeling compound may fit within the total mold volume of a cavity formed between the front mold portion and the back mold portion with at least a portion of a substrate, such as a digit of a user's hand is pushed into the molding cavity of the openable interlocking molding device via an opening formed to receive the modeling compound when the openable interlocking molding device is assembled. In some aspects, the openable interlocking molding device is disassembled by moving the first molding component and the second molding component in a dismantling direction away from one another. The molding cavity is configured to receive the modeling compound from a direction of entry orthogonal to the dismantling direction of the openable interlocking molding device.

The modeling compound used with the openable interlocking molding device in accordance herein may include, for example, a prepackaged volume of the modeling compound that is configured to sufficiently fill the total internal volume of the molding cavity of the openable interlocking molding device. By “sufficiently fill” in accordance with aspects herein, it is meant that the molding cavity is fully packed with the modeling compound such that mold features on the concave surfaces of the molds become embedded in the outer surface of the mold and remain visible upon release of the mold from the modeling compound. In some aspects, the volume of the modeling compound configured to be retained within the cavity of the interlocking mold components may correspond to that available from a prepackaged SILLY PUTTY® filled-egg product, and the modeling compound may be configured to receive embossing characteristics on its surface once forced into contact with the surrounding mold features. In additional aspects, any portion of the molding cavity less than the total internal volume is utilized.

In some aspects, a user may wrap the modeling compound around a finger and/or thumb, and use the covered finger as a base structure to receive the openable interlocking molding device by assembling the openable interlocking molding device over the wrapped finger, as will become more apparent with respect to the figures (e.g., by moving the openable interlocking molding device in an assembling direction). In other aspects, the user may pre-assemble the openable interlocking molding device and then push the modeling compound through the opening and then disassemble the openable interlocking molding device (e.g., in the dismantling direction) to reveal the shaped and embossed modeling compound. By applying force through the pushing action, the modeling compound is forced to contact every mold feature (e.g., ridges, valleys, and the like) of the molding cavity/surface of the openable interlocking molding device. In other words, the modeling compound may be forced into contact with the interior surface of the molding cavity, forming a detailed embossed surface on the modeling compound that remains visible once the openable interlocking molding device is dismantled. As used herein, a ridge refers generally to a portion of a molding surface, wherein the portion has an elevation displaced in a first direction with respect to the molding surface. A valley, as used herein, refers generally to a portion of a molding surface, wherein the portion has an elevation displaced in a second direction that is opposite the first direction with respect to the molding surface.

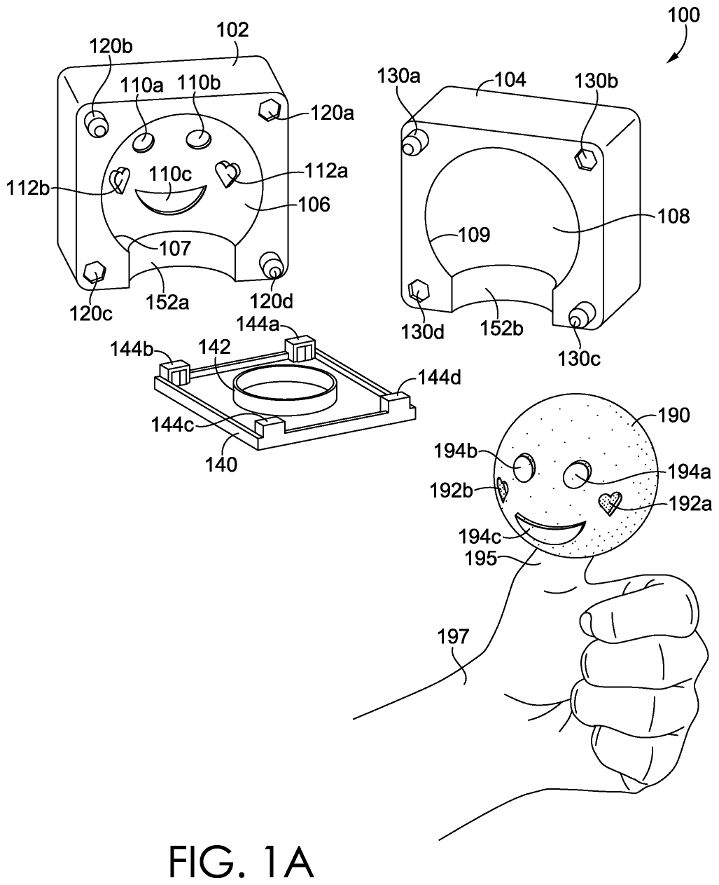

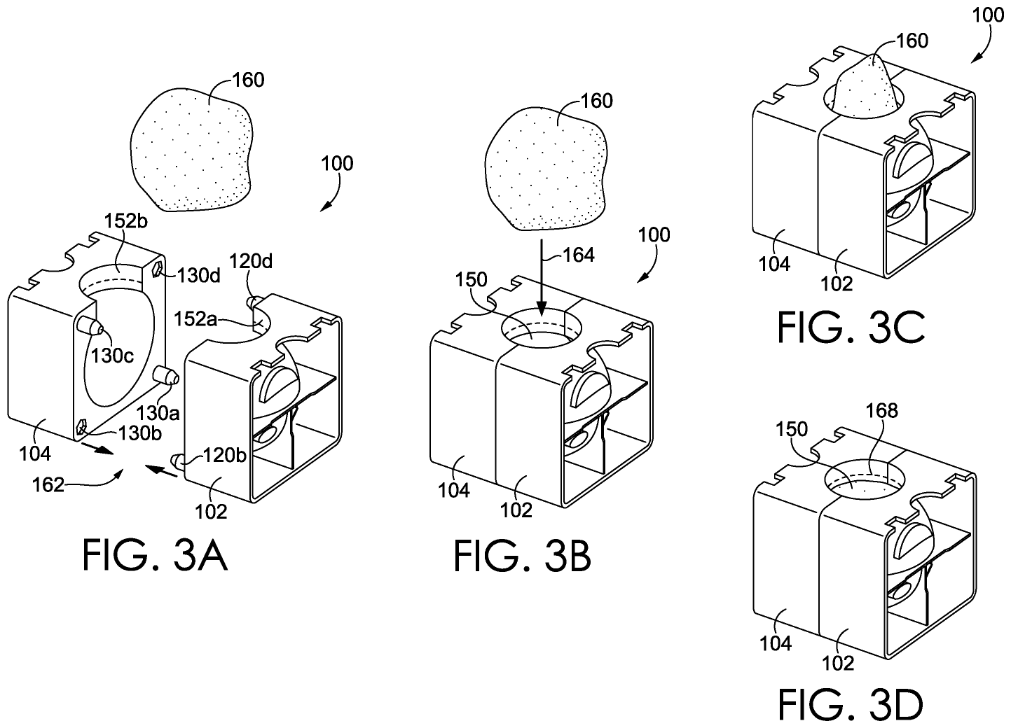

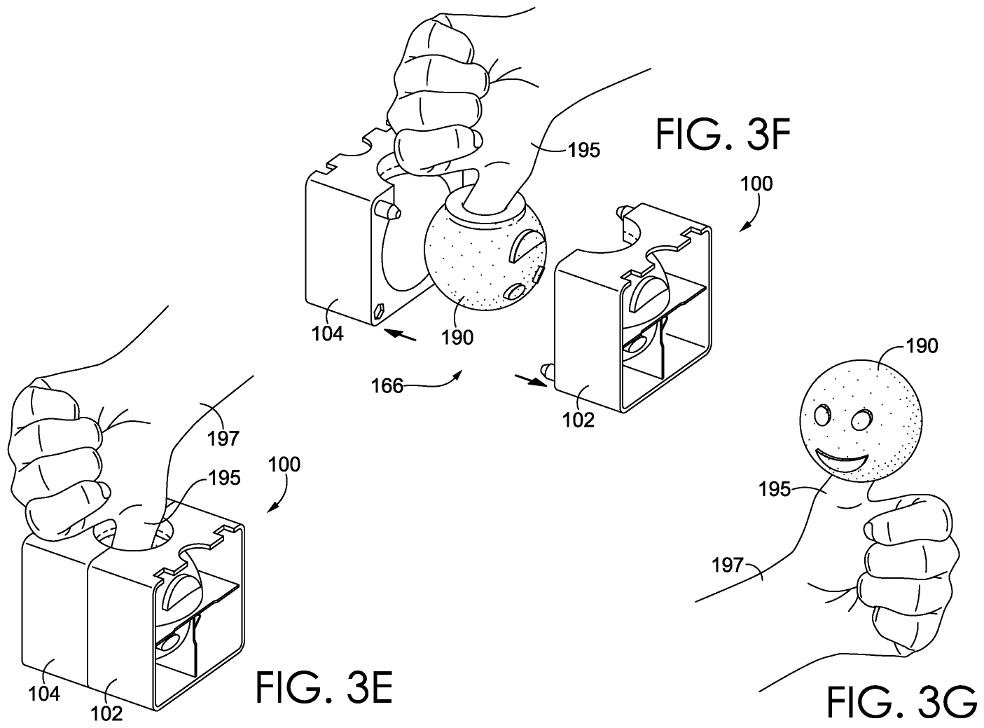

Moving onto FIG. 1, an exemplary dismantled openable interlocking molding device 100 in accordance with aspects herein is shown. As shown, the openable interlocking molding device 100 is comprised of a first molding component 102 comprising a first concave molding surface 106 and a second molding component 104 comprising a second concave molding surface 108, where the first concave molding surface 106 is configured to provide embossing characteristics, and where the second concave molding surface 108 is configured to provide embossing characteristics. The first concave molding surface 106 and the second concave molding surface 108, when brought together by assembling the openable interlocking molding device 100, substantially complement each other to form a molding cavity. By “substantially complementing” each other, in accordance with aspects herein means that at least 70% of a first perimeter 107 of the first concave molding surface 106 matches a second perimeter 109 of the second concave molding surface 108. Each of the first concave molding surface 106 and the second concave molding surface 108 may optionally comprise a plurality of ridges (112a and 112b) and a plurality of valleys (110a, 110b, and 110c) (i.e., mold features), as in the first concave molding surface 106 of first molding component 102. The plurality of ridges (112a and 112b) and the plurality of valleys (110a, 110b, and 110c) being configured to provide/impress the embossed characteristics to the modeling compound 160 (shown in FIG. 3A), resulting in a molded modeling compound 190, as shown, where the ridges 112a and 112b created the recesses 192a and 192b, while the valleys 110a, 110b, and 110c created the protrusions 194a, 194b, and 194c, respectively.

The openable interlocking molding device 100 comprises a first coupling mechanism comprised of elements 120a, 120b, 120c, 120d on first molding component 102, and elements 130a, 130b, 130c, 130d on second molding component 104, for coupling the first molding component and the second molding component to each other. The elements 120a, 120b, 120c, 120d on first molding component 102 and the elements 130a, 130b, 130c, 130d on second molding component 104 may be integrally formed with the respective molding components during the manufacturing process of the openable interlocking molding device 100. As shown, the first coupling mechanism may be comprised of a peg and hole system, where the elements 120b, 120d, 130a, and 130 are shown as pegs, and elements 120a, 120c, 130b, and 130d are shown as holes. The pegs are configured to fit through the holes so that the first molding component 102 becomes immobilized relative to second molding component 104 when the pegs are fitted through the respective holes. The configuration of pegs and holes shown in the figures is only exemplary and it is contemplated that the pegs and holes may be located in any configuration as long as the pegs and holes are located opposite relative to each other on the respective first molding component 102 and second molding component 104. For example, instead of the first coupling mechanism being configured as shown, elements 120a and 120b may both be pegs and elements 130a and 130b may be respective holes configured to receive the pegs of elements 120a and 120b. In other words, it is contemplated that twenty four different configurations for the first coupling mechanism having four total elements on each molding component is possible. Further, although each molding component is shown as having four elements of the first coupling mechanism, it is also contemplated that only two, or only three elements may be provided per molding component. Particularly, depending on the overall shape (e.g., cube, as shown) of the assembled openable interlocking molding device 100, as will become more apparent in view of later figures. Further, although the holes, as shown, comprise a hexagonal shape, it is contemplated that the holes may comprise any other geometric suitable shape, such as, for example, circular, triangular, star, square, and the like. Similarly, the pegs, although shown as having a cylindrical/frustum of a cone shape, the pegs may have any other suitable shapes, such as, for example, rectangular prism, a cone, a parabolic cone, and the like, as well as frusta of these shapes.

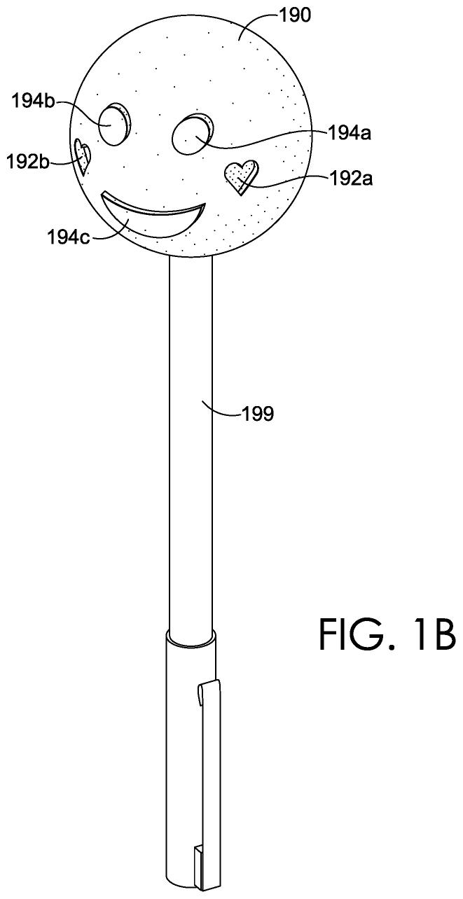

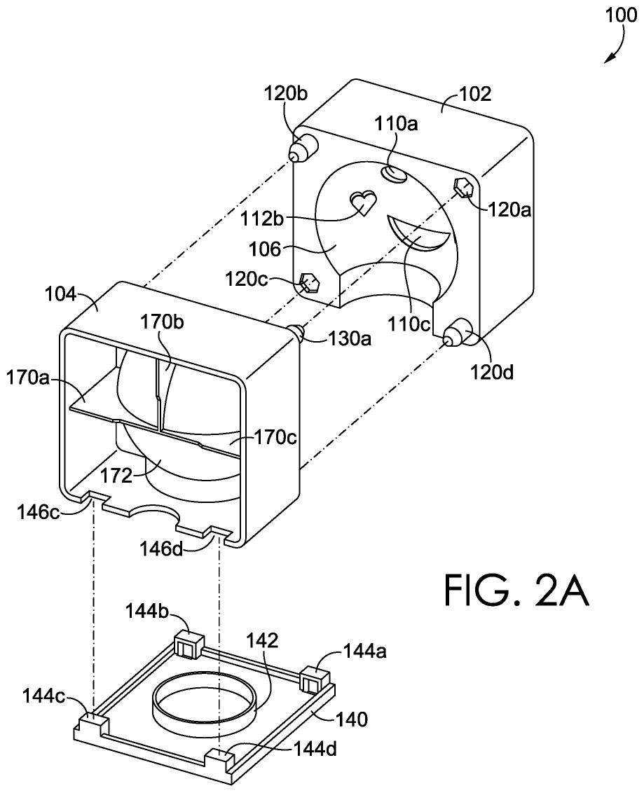

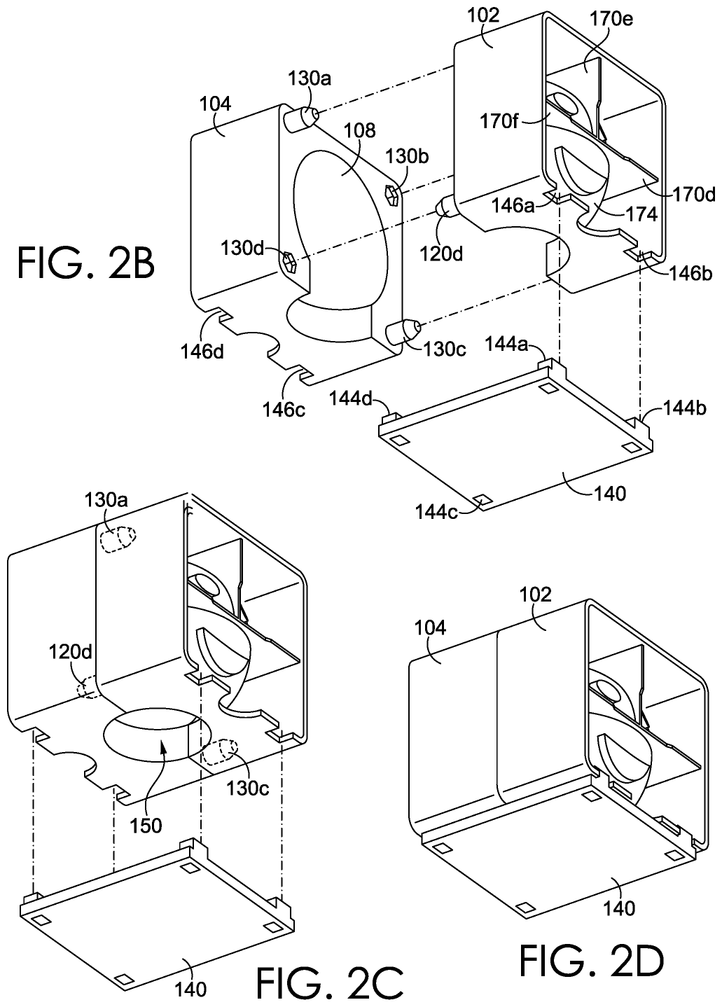

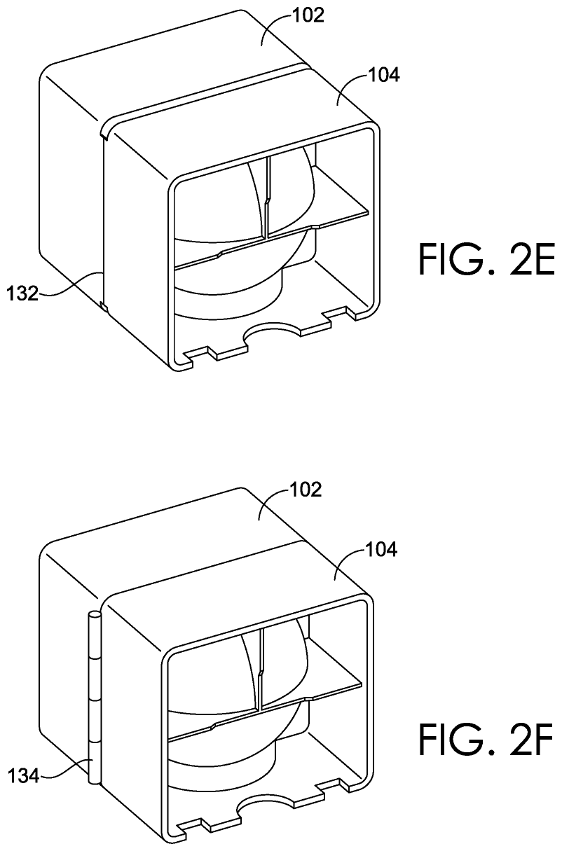

Continuing on FIG. 1, as shown, the openable interlocking molding device 100 may further comprise a capping component 140 configured to close the cavity opening 150 (shown in FIG. 2C) formed by an opening perimeter 152a located at first molding component 102 and opening perimeter 152b located at second molding component 104. The capping component 140 comprises a capping lip 142 configured to seal the cavity opening 150 when the capping component is installed onto the openable interlocking molding device 100; and a second coupling mechanism comprised of a plurality of prongs 144a, 144b, 144c, and 144d, configured to fit into notches 146a, 146b, 146c, and 146d (shown in FIG. 2B). As such, the molding cavity of the assembled openable interlocking molding device 100 may be used to store the modeling compound 160, when not in use.

In accordance with further aspects herein, when the modeling compound 160 is forced against the first concave molding surface 106 of first molding component 102 and second concave molding surface 108 of second molding component 104 when the openable interlocking molding device 100 is assembled, by pushing against the modeling compound 160 once it is inside of the molding cavity by, for example, a user's digit 195 (e.g., thumb, as shown), the molded modeling compound 190 may be revealed as being shaped and embossed with surface characteristics given by the respective concave surfaces of each of the first molding component 102 and the second molding component 104. As shown in FIG. 1B, instead of a digit, the user 197 may use an external tool such as a pen 199 (as shown), a pencil, a crayon, a wooden stick, a toy, and the like, to exert a force on the modeling compound 160 through the mold opening (not shown) to force the modeling compound 160 against the surfaces of the first molding component 102 and the second molding component 104.

Moving on to FIGS. 2A-2D, FIGS. 2A-2D depict an assembling representation of the openable interlocking molding device 100. At FIG. 2A, for example, a dismantled version of the openable interlocking molding device 100 is shown, where the first molding component 102 is aligned with the second molding component 104 such that the first coupling mechanism has elements 120a, 120b, 120c, and 120d aligned with elements 130a, 130b, 130c, and 130d, respectively. Further, elements 120a and 120b may both be pegs and elements 130a and 130b may be respective holes configured to receive the pegs of elements 120a and 120b. Further, FIGS. 2B-2C, show how capping component 140 is also aligned with the first molding component 102 and the second molding component 104 to illustrate how the second coupling mechanism comprised of prongs 144a, 144b, 144c and 144d would engage with notches 146a, 146b, 146c and 146d, respectively to cap the openable interlocking molding device 100. Particularly, FIG. 2C illustrates how the first coupling mechanism completely engages the first molding component 102 and the second molding component 104, and FIG. 2D illustrates how the capping component 140 engages the first molding component 102 and the second molding component 104 with the second coupling mechanism, thereby sealing the cavity opening 150 into the molding cavity.

As shown in the figures herein, the openable interlocking molding device 100 is configured to have a general cube shape when completely assembled (see FIG. 2D), where each of the first molding component 102 and the second molding component 104 are shaped as a half cubes. The general cube shape may facilitate storage when provided with multiple different openable interlocking molding device(s) 100, for example, as the openable interlocking molding device(s) 100 would be stackable. However, it is contemplated that the general shape of the openable interlocking molding device 100 may be any shape, or any other 3D shape suitable such as, for example, any geometric three dimensional shape such as a sphere, a pyramid, a rectangle, and the like.

Further, as shown, the first molding component 102 and the second molding component 104 of the openable interlocking molding device 100 are generally hollow on the opposite side of the first concave molding surface 106 and second concave molding surface 108, respectively. This feature provides several advantages to the openable interlocking molding device 100 such as reducing the amount of material needed to produce the openable interlocking molding device 100, reducing the total weight of the openable interlocking molding device 100, and providing a preview into the resulting construct, such as molded modeling compound 190, that would be formed from the modeling compound 160 by using the openable interlocking molding device 100. This is because the first concave molding surface 106 would manifest as first convex surface 174 and second concave molding surface 108 would manifest as second convex surface 172. Although optional, the tabs 170a, 170b, 170c, 170d, 170e, and 170f may serve in packaging, such as, for example, when shrink wrapping. The openable interlocking molding device 100 may be manufactured from a thermoplastic material, such as, for example, a polypropylene plastic. The tabs 170a, 170b, 170c, 170d, 170e, and 170f may also serve to stabilize the first concave molding surface 106 and the second concave molding surface 108 during manufacture of the openable interlocking molding device 100. For example, to prevent the first convex surface 174 and the second convex surface 172 from bowing in during a high temperature molding process of the openable interlocking molding device 100. Further, although the first molding component 102 and the second molding component 104 are shown as being two separate components, it is also contemplated that they may be secured to each other by, for example, a living hinge 132 as shown at FIG. 2E, a jointed hinge 134 as shown in FIG. 2F, and the like.

FIGS. 3A-3G illustrate steps for using the openable interlocking molding device 100. As shown in FIG. 3A, a user 197 would gather a first molding component 102 and a second molding component 104 and assemble them together by bringing them towards each other in a first direction 162, and fitting elements 120a, 120b, 120c, and 120d with elements 130a, 130b, 130c, and 130d of the first coupling mechanism, as shown in FIG. 3A. Once the cavity opening 150 for accessing the molding cavity is formed by bringing together opening perimeter 152a and 152b, modeling compound 160 may be inserted through the cavity opening 150 in a second direction 164, where the first direction 162 is orthogonal to the second direction 164, as shown in FIGS. 3B and 3C. Once the modeling compound 160 is tucked into the molding cavity below, for example fill line 168, as shown in FIG. 3D, a user 197 may insert a substrate, such as, for example, the user's digit 195 of the user 197, through the cavity opening 150 in the second direction 164, as shown in FIG. 3E. When the user 197 applies pressure on the modeling compound 160 in the second direction 164, the modeling compound 160 becomes further pressed against the first concave molding surface 106 and second concave molding surface 108. The first concave molding surface 106 and the second concave molding surface 108 may be treated to create a vapor home in order to facilitate release of the molded modeling compound 190 as the first molding component 102 and the second molding component 104 are dismantled by pulling them apart in a third direction 166, as shown in FIG. 3F. Once the molded modeling compound 190 is released from the openable interlocking molding device 100, the user 197 may be free to play with the molded modeling compound 190, as shown in FIG. 3G.

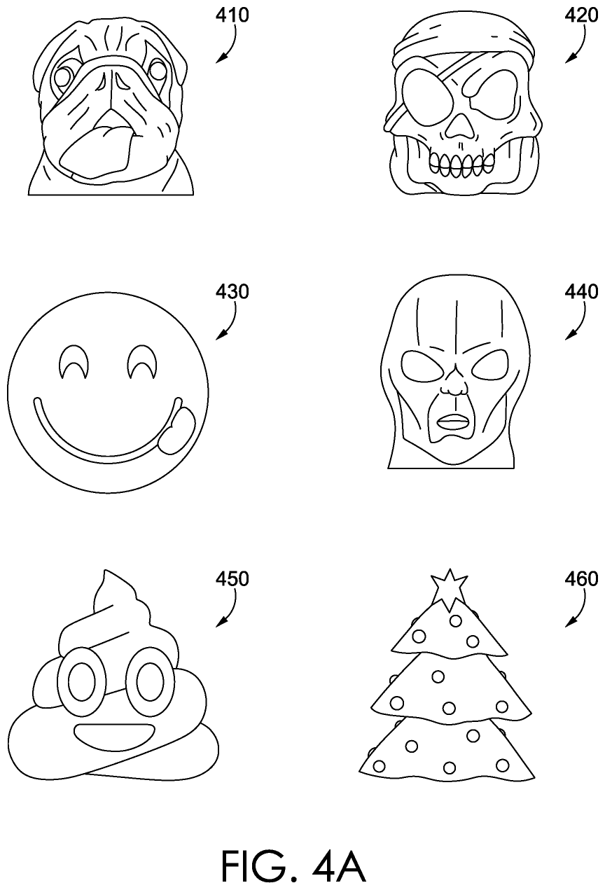

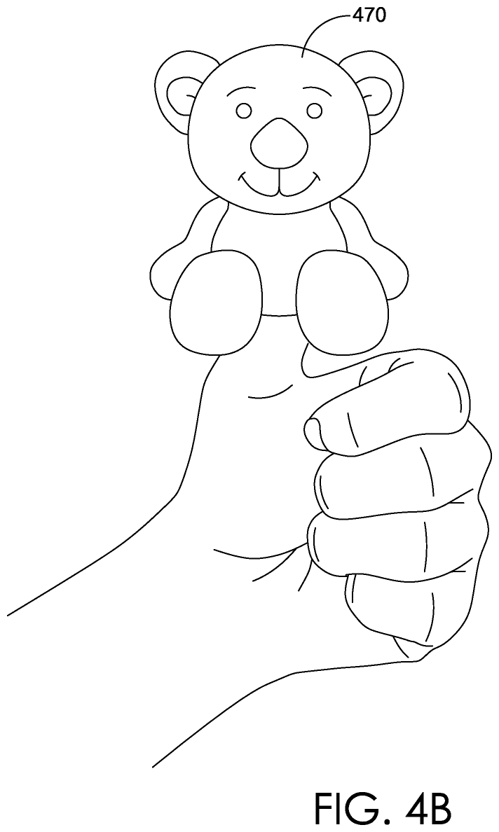

Moving on to FIGS. 4A and 4B, different exemplary molded modeling compounds are shown. These are only exemplary and it is contemplated that any character, toy, animal, and the like may be molded. For example, a dog head, 410, a skull, 420, an emoji 430 or 450, a character face 440, a tree 460, a full body teddy bear 470, and the like.

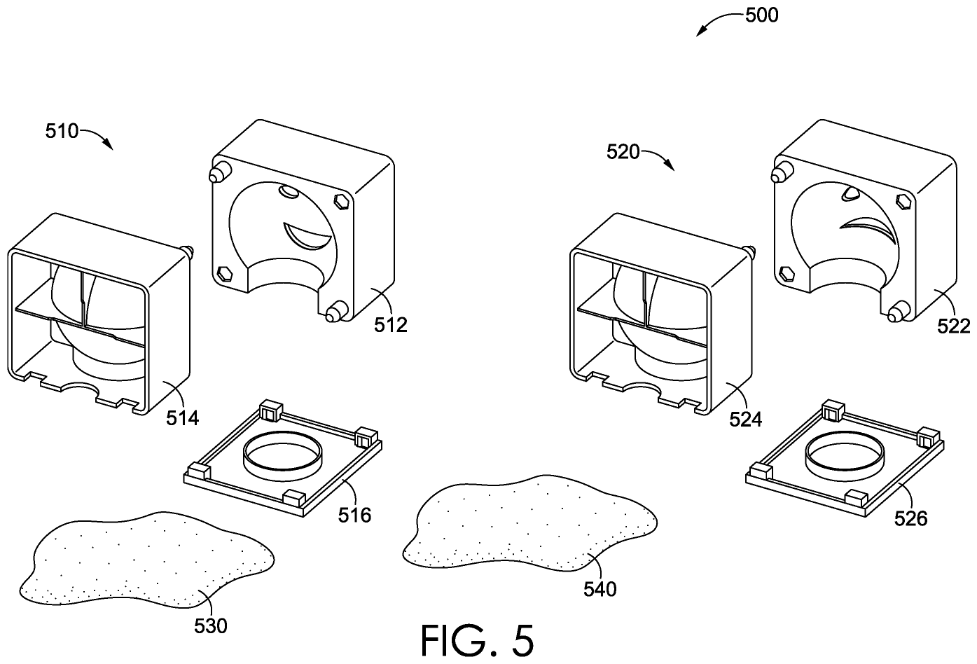

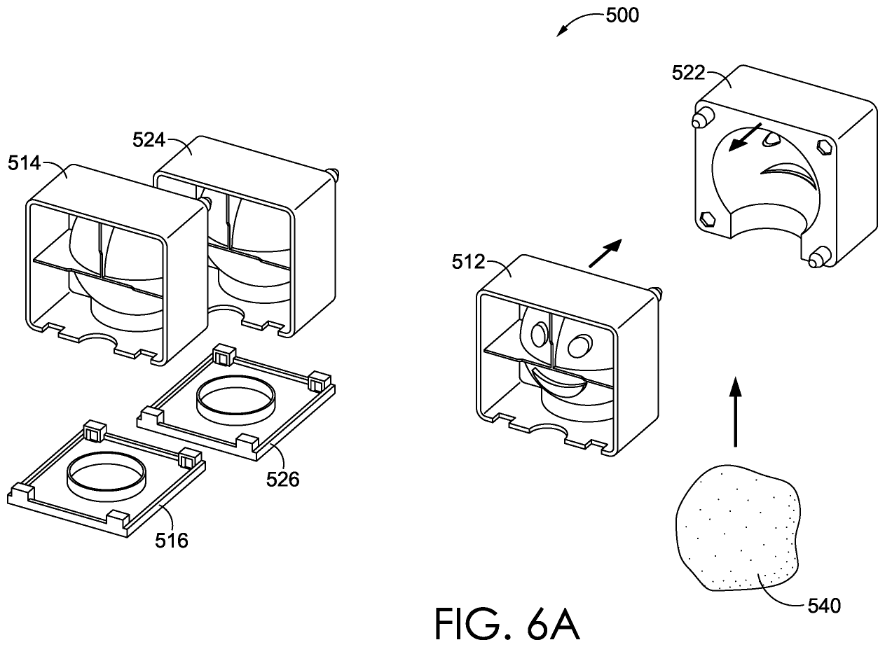

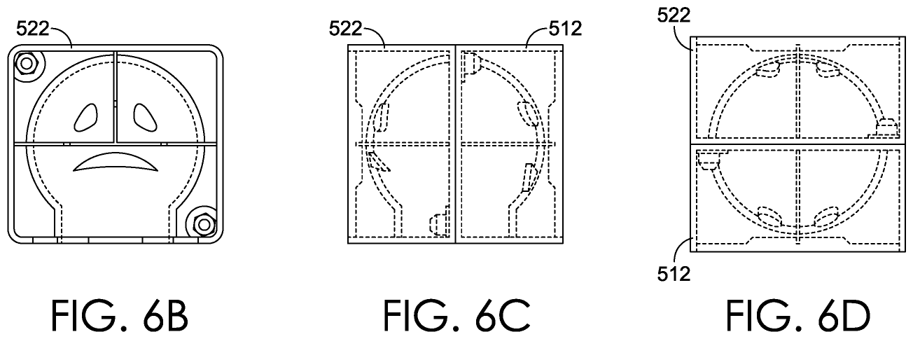

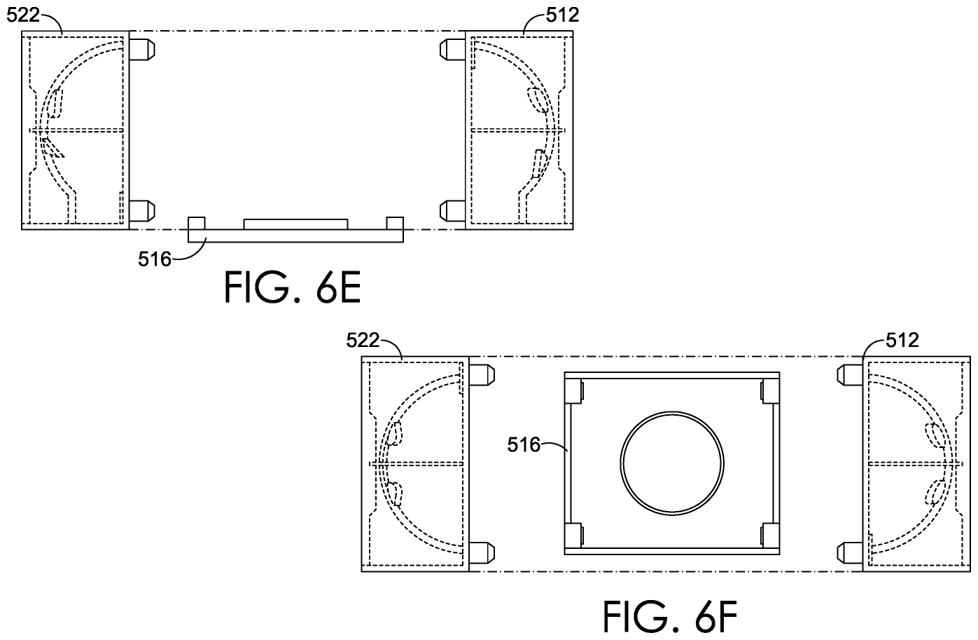

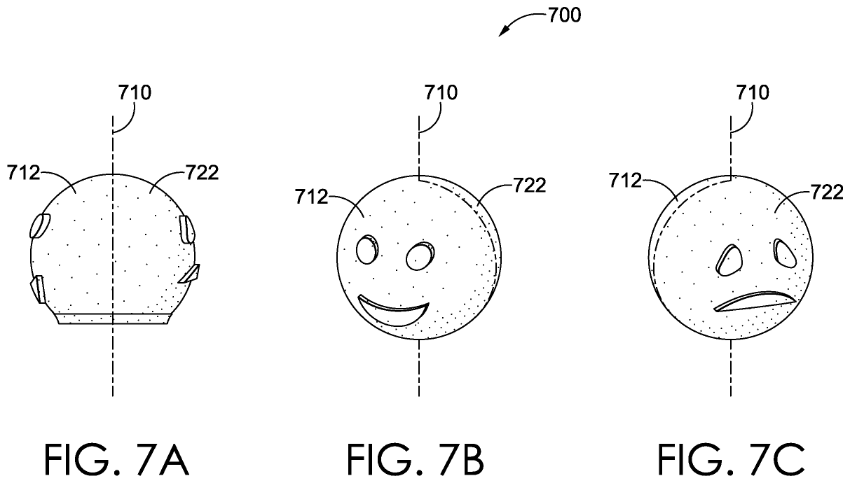

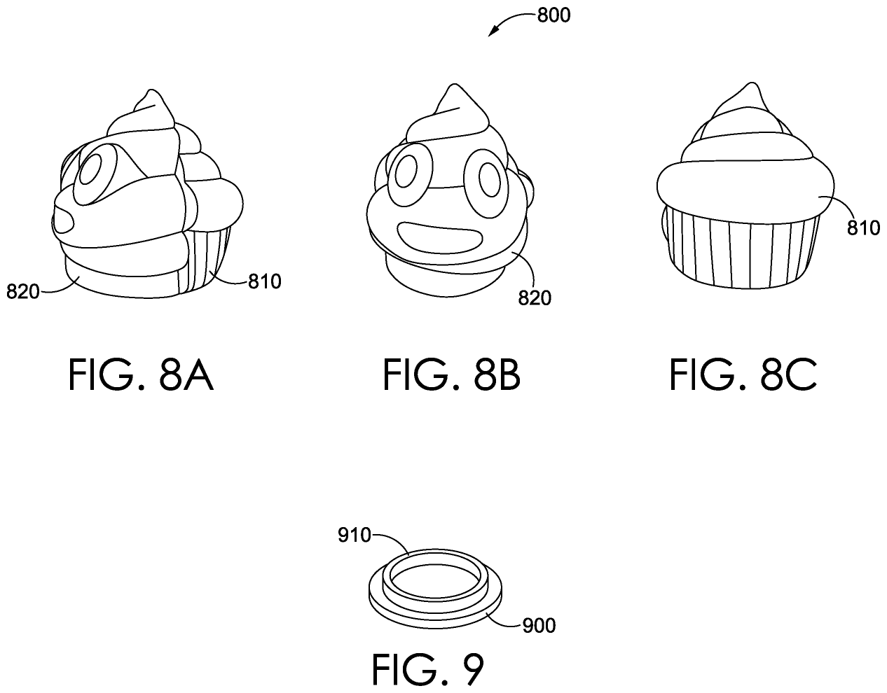

FIG. 5 illustrates a kit 500 comprised of two openable interlocking molding devices 510 and 520 and two modeling compounds 530 and 540 is shown. The kit 500 is only exemplary, as it is contemplated that a kit in accordance with aspects herein, may be comprised of one, two, three, four, five, six, seven, eight, nine, ten, etc. molding devices and modeling compounds, respectively. Once a user has at least two openable interlocking molding devices, as shown in FIGS. 6A-6F, it is contemplated that the molding component 512, the molding component 514, the molding component 522, and the molding component 524, the capping component 516, and the capping component 526, for example, may be interchangeable with each other. For example, molding component 512 and 522 may be assembled with each other, as shown in FIGS. 6A-6F, to create a double sided/two faced molded modeling compound 700, as shown in FIGS. 7A-7C, and following the steps as described above with reference to FIGS. 3A-3G. The double sided/two faced molded modeling compound 700 is comprised of a happy face 712 and a sad face 722, as divided, by for example the imaginary plane 710. Another exemplary double sided/two faced modeling compound 800 is shown, having an emoji side 820 and a cupcake side 810. Although the capping components 616 and 626 are shown to have the configuration of capping component 140, as shown in FIG. 1A, for example, it is also contemplated that the capping component may be in the form of a plug 900 with lip 910 for plugging the opening to the molding cavity formed when two molding components are assembled together.

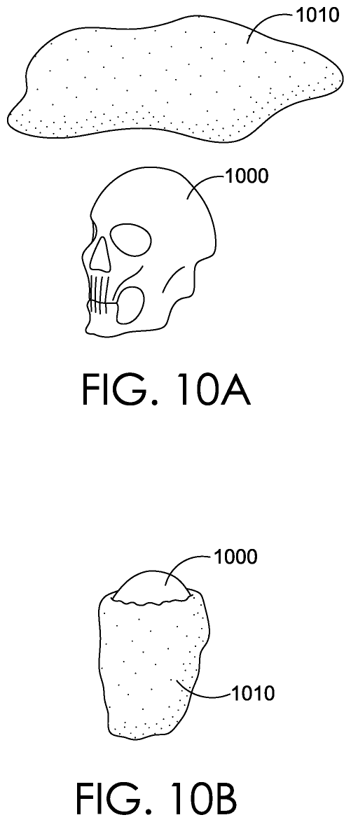

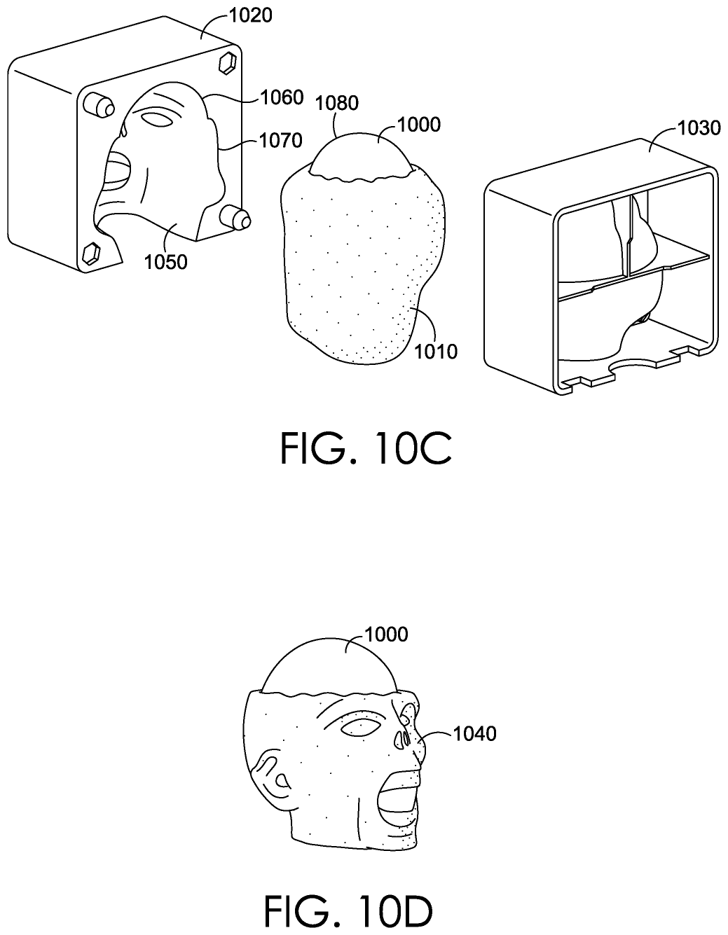

In accordance with further aspects herein, a substrate structure 1000 may be provided, as shown in FIGS. 10A-10D. For example, the substrate structure 1000 may be formed from a hard, non-porous material. “Hard” in accordance with aspects herein, may be any material that has a greater hardness than the modeling compound and is able to permanently retain its shape at room or colder temperatures. Exemplary materials may include, for example, thermoplastic materials, glass, stone, metal, treated wood, glass, silicone, and the like. Once the substrate structure 1000 is provided, the modeling compound 1010 may be wrapped around the substrate structure 1000, as shown in FIG. 10B. The modeling compound 1010 wrapped substrate structure 1000 may be fitted inside a molding cavity formed by concave molding surface 1050 of molding component 1020 and a concave molding surface of molding component 1030, as shown in FIG. 10C, to produce the molded modeling compound 1040 on the substrate structure 1000 to create, for instance in this example, a skin effect on the substrate structure 1000. The molding cavity's perimeter may comprise one or more portions that tightly fit the substrate such as perimeter portion 1060, while other one or more portions of the perimeter may have a modeling compound fitting gap, such as perimeter portion 1070. As the substrate structure 1000, most or all of the substrate structure (e.g., at least 90%) may be fitted inside the concave molding surface 1050 of molding component 1020 and of the fitted inside the molding cavity of molding component 1030.

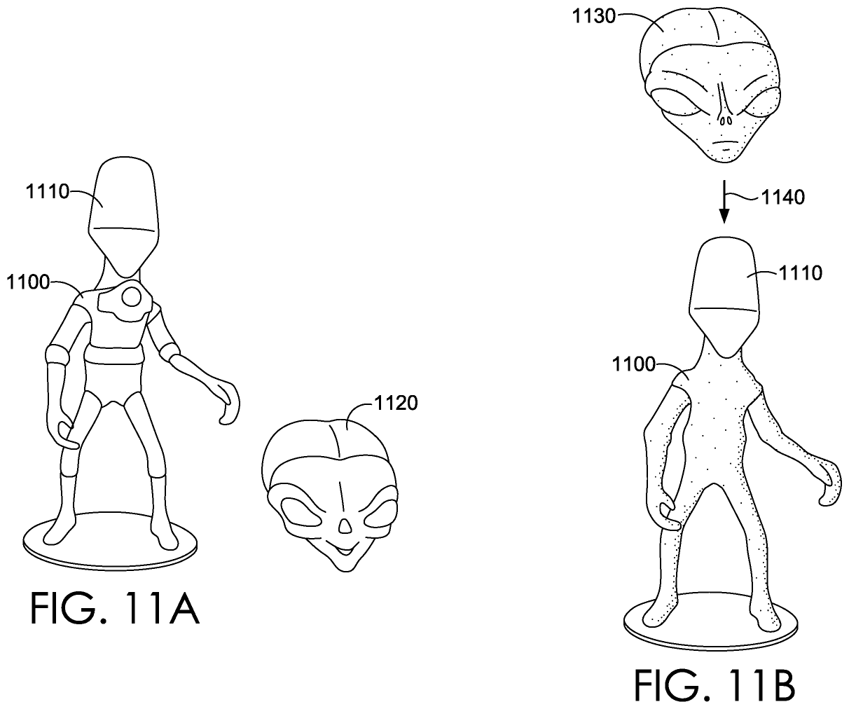

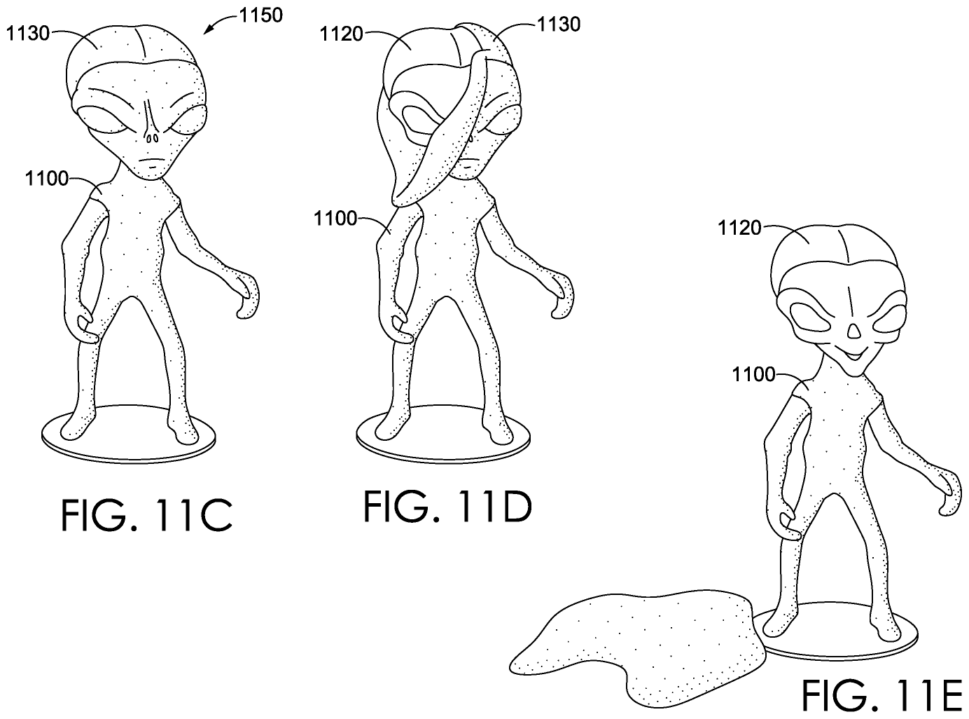

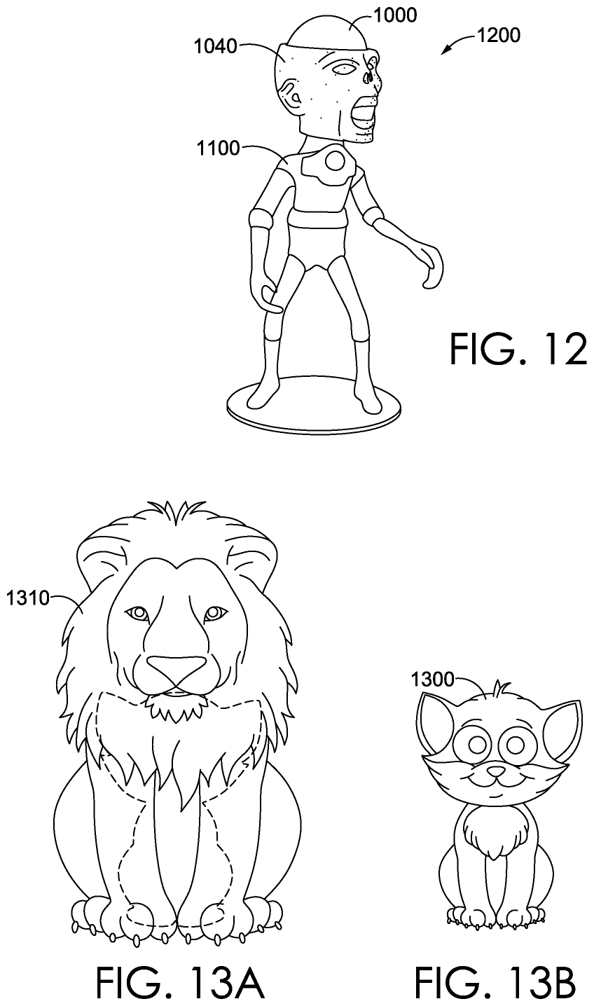

In other examples, such as the one shown in FIGS. 11A-11E, the full body substrate structure 1100 may be a full body toy with a substrate coupling portion 1110, configured to fit, for example, a substrate head portion 1120 having certain characteristics, where the substrate head portion 1120 may comprise certain characteristics related to the full body substrate structure 1100, such as an alien smiling face, as shown. When a molding compound is wrapped around an entire surface of the substrate head portion 1120 and molded with a corresponding molding compound in accordance with aspects herein, to mold, for example, an angry alien face, the resulting molded modeling compound 1130, as shown in FIG. 11B may result. Further, the rest of the full body substrate structure 1100 may optionally, also be wrapped in a modeling compound, as also shown in FIG. 11B. Then, the molded modeling compound 1130 may be fitted onto substrate coupling portion 1110 in, for example, a direction 1140 to result in the molded full body toy 1150, as shown in FIG. 11C. As the molded modeling compound 1130 is pealed off of the substrate head portion 1120 and/or left to fall off by another force, such as gravity, as shown in FIG. 11D, the substrate head portion 1120 may be slowly revealed to add an element of surprise and another dimension to the play experience to give the full body substrate structure 1100 a dynamic play experience, allowing one toy to have “two faces” such as, for example, as shown in FIGS. 11C and 11E. Further, as shown in FIG. 12, the substrate head portion 1120 may be interchangeable with other substrate head portions such as, for example, the substrate structure 1000 with molded modeling compound 1040 from FIG. 10D to result in a toy structure 1200, for example. In another aspect, the substrate structure 1300 may be, for example, a surprise hidden inside a molded modeling compound 1310, as shown in FIGS. 13A and 13B. For example, in FIG. 13B, the substrate structure 1300 is a cat hidden inside a lion molded from the molded modeling compound 1310.

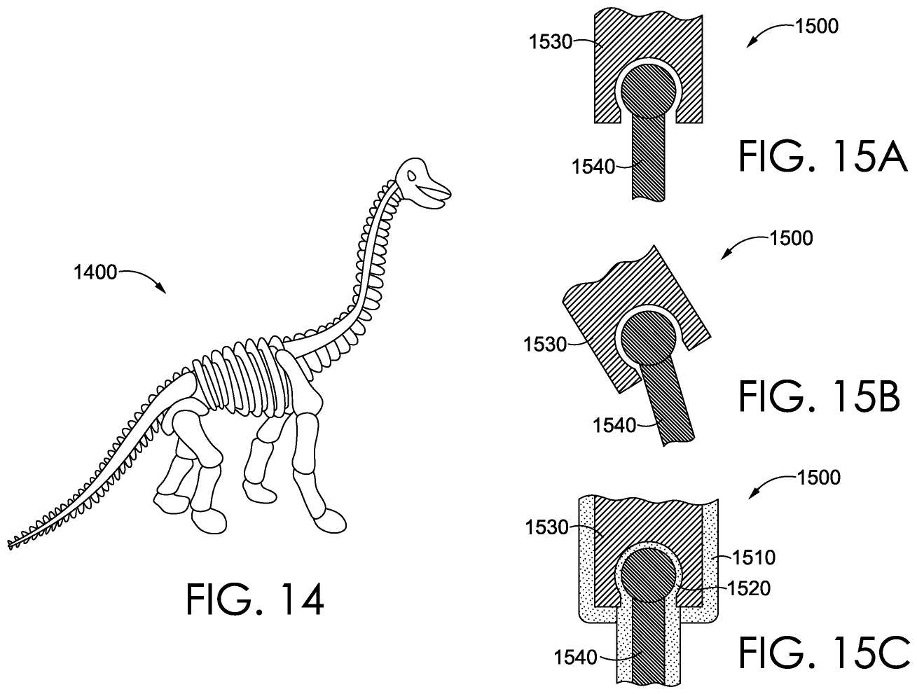

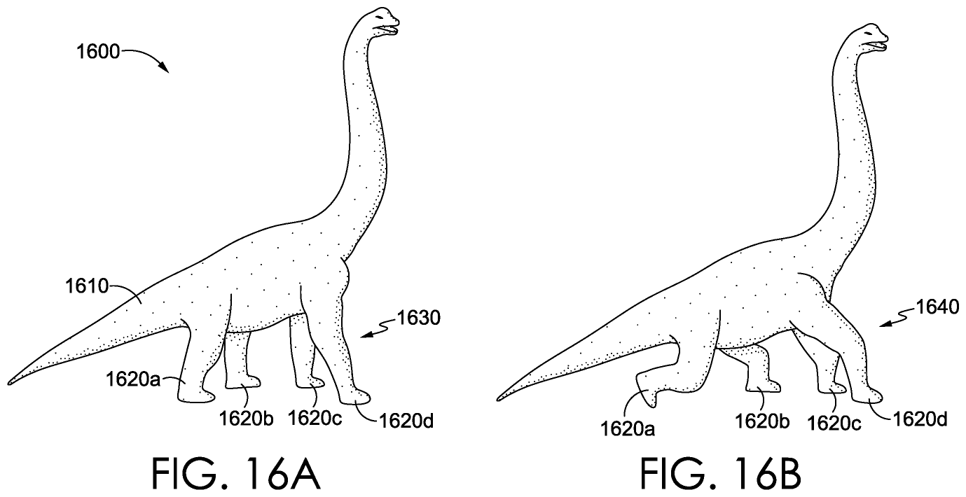

Furthermore, in accordance with other aspects herein, as shown in FIG. 14, the substrate may be in the form of an armature 1400 comprised of movable joints such as movable joint 1500 shown in FIGS. 15A-15C. As shown in FIG. 14, the armature 1400 with movable joints may be, for example, an animal skeleton with movable leg joints, and/or other movable body parts. The joints may be configured as a ball and socket joint, such as movable joint 1500, shown in FIGS. 15A-15C, or may be configured as other types of joints such as hinged joints, pivot joints, gliding joints, and the like. Taking the movable joint 1500 as an example, formed from socket portion 1530 and ball portion 1540, when molding a modeling compound 1510 over the armature 1400, for example as shown in FIG. 15C, the movable joint 1500 may initially be maintained in a first position by having the modeling compound 1510 completely envelope the movable joint 1500 and in some cases, squeeze through gaps (e.g. 1520) present between the socket portion 1530 and the ball portion 1540 of the movable joint 1500. For example, FIGS. 16A and 16B shows, for example, the armature 1400 completely enveloped by a modeling compound 1610 to form a dinosaur figurine 1600 with detailed skin and flesh properties. Since the modeling compound 1610 may fluid to a certain extent, such as for example, SILLY PUTTY®, available from Crayola LLC, Easton, Pa., the force of gravity may cause the joints in, for example, legs 1620a, 1620b, 1620c, and 1620d to go from an initial straight first position 1630 to a second position 1640, where the legs 1620a, 1620b, 1620c, and 1620d are bent, causing movement in the dinosaur figurine 1600, thereby giving the impression that the dinosaur figurine 1600 is able to move on its own.

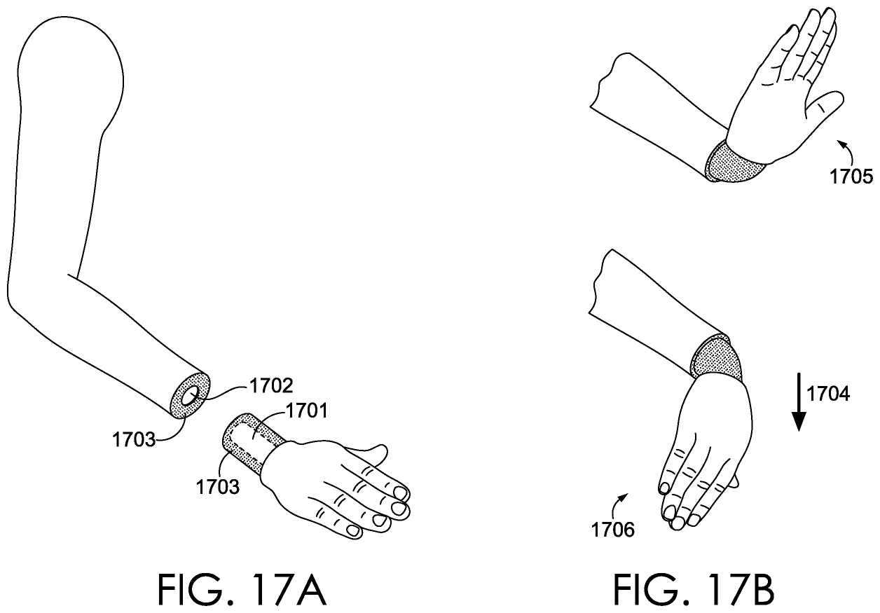

By way of further example, FIGS. 17A and 17B depict another substrate comprised of movable joints. The movable joints may comprise a filament or male member 1701 protruding from a first portion of the substrate. In this instance, the filament 1701 is protruding from a hand portion of the substrate/armature. The filament 1701 is configured to be inserted into an opening 1702 of a second portion of the substrate (e.g., the wrist portion in the current example). The filament 1701 and/or opening 1702 may be covered with a modeling compound 1703. The modeling compound 1703 may be applied to the filament 1701 and/or the opening 1702 prior to insertion of the filament 1701 into the opening 1702, after insertion of the filament 1701 into the opening 1702, or a combination thereof. The modeling compound 1703 may be applied such that the joint is positioned in a first position 1705, illustrated in FIG. 17B. Once the hand and modeling compound 1703 travels from its original location (e.g., by gravity) in a direction 1704, for example, the joint would result in a second position 1706. Further, the user could position the filament substrate into the flexible modeling compound in any starting position desired by the user.

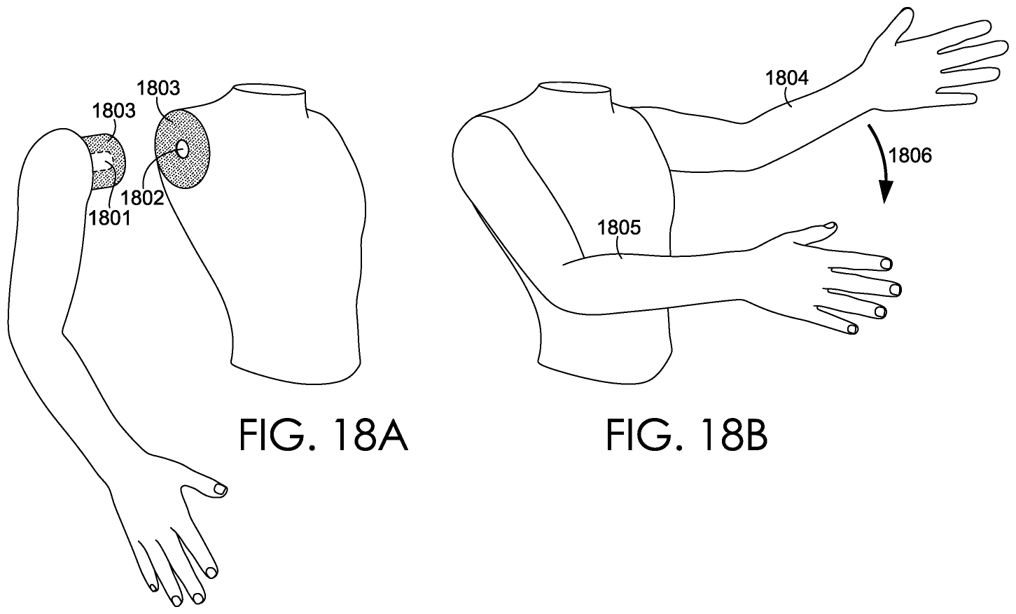

By way of further example, FIGS. 18A and 18B provide a substrate comprising movable joints. The movable joints may comprise a filament or male member 1801 protruding from an arm portion of the substrate. The filament 1801 is configured to be inserted into an opening 1802 of a second portion of the substrate (e.g., torso). The filament 1801 and/or opening 1802 may be covered with a modeling compound 1803. The modeling compound 1803 may be applied prior to insertion of the filament 1801 into the opening 1802, after insertion, or a combination thereof. With the filament 1801 into the opening 1802 and the modeling compound 1803 applied, a user may place an arm 1804 into a first position as illustrated in FIG. 18B. As gravity pulls the arm down, the modeling compound may provide resistance to the movable joint allowing the arm to descent in a controlled, fluent fashion to a second position 1805 in direction 1806, as shown in FIG. 18B.

While the previous examples have illustrated movable joints in the context of a ball and socket-type joint or a filament and opening-type joint, it is understood that any type of connection may be utilized that allows for a freedom of movement consistent with a joint. It may be appreciated that different types of connections provide varying freedom of movement and, thus, different armatures may benefit from the use of a variety of connections for the joints thereof. Furthermore, it may be apparent to one of skill in the art that the sizes of the openings, filaments, sockets, etc., may be adjusted to further control the range of motion.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A molding system comprising:
a first molding component having a first molding surface comprising one or more first molding features, wherein the one or more first molding features are configured to provide one or more first embossed characteristics to a modeling compound;
a second molding component having a second molding surface comprising one or more second molding features, wherein the one or more second molding features are configured to provide one or more second embossed characteristics to the modeling compound; and
a substrate comprising:
a first substrate portion having first substrate surface and a first joint portion;
a second substrate portion having a second substrate surface and a second joint portion;
wherein the first joint portion and the second joint portion cooperate with each other to form a movable joint and wherein the first substrate surface and the second substrate surface are configured to be enveloped by the modeling compound.

2. The molding system of claim 1, wherein the movable joint is a ball and socket joint, wherein the first joint portion is a ball portion and wherein the second joint portion is a socket portion.

3. The molding system of claim 1, wherein the first joint portion is a filament and wherein the second joint portion is an opening configured to receive the filament.

4. The molding system of claim 1, wherein the first molding component and the second molding component are comprised of a non-porous rigid material.

5. The molding system of claim 1, wherein the first molding component and the second molding component are secured to each other by a hinge.

6. The molding system of claim 1, wherein the first molding component comprises a first coupling mechanism, wherein the second molding component comprises a second coupling mechanism, and wherein the first coupling mechanism and the second coupling mechanism cooperate to couple the first molding component to the second molding component.

7. A molding kit comprising:
a quantity of a modeling compound
a first molding component having a first molding surface comprising one or more first molding features, wherein the one or more first molding features are configured to provide one or more first embossed characteristics to the quantity of the modeling compound;
a second molding component having a second molding surface comprising one or more second molding features, wherein the one or more second molding features are configured to provide one or more second embossed characteristics to the quantity of the modeling compound; and
a substrate comprising:
a first substrate portion having first substrate surface and a first joint portion;
a second substrate portion having a second substrate surface and a second joint portion;
wherein the first joint portion and the second joint portion cooperate with each other to form a movable joint and wherein the first substrate surface, the second substrate surface.

8. The molding kit of claim 7, wherein the movable joint is a ball and socket joint, wherein the first joint portion is a ball portion and wherein the second joint portion is a socket portion.

9. The molding kit of claim 7, wherein the movable joint is configured to shift from at least a first position to a second position.

10. The molding kit of claim 7, wherein the first substrate portion and the second substrate portion are part of a movable armature.

11. The molding kit of claim 10, wherein the quantity of the modeling compound is configured to envelop the movable armature.

12. The molding kit of claim 11, wherein the movable armature is an animal skeleton.

13. The molding kit of claim 12, wherein the one or more first embossed characteristics and the one or more second embossed characteristics on the quantity of the modeling compound enveloping the animal skeleton correspond to skin characteristics that complement the animal skeleton.

14. The molding kit of claim 7, wherein the first molding component and the second molding component are comprised of a non-porous rigid material.

15. The molding kit of claim 7, wherein the first molding component and the second molding component are secured to each other by a hinge.

16. The molding kit of claim 7, wherein the first molding component comprises a first coupling mechanism, wherein the second molding component comprises a second coupling mechanism, and wherein the first coupling mechanism and the second coupling mechanism cooperate to couple the first molding component to the second molding component.

17. A molding device comprising:
a first molding component having a first molding surface comprising one or more first molding features, wherein the one or more first molding features are configured to provide one or more first embossed characteristics to a modeling compound; and
a second molding component having a second molding surface comprising one or more second molding features, wherein the one or more second molding features are configured to provide one or more second embossed characteristics to the modeling compound;
wherein the modeling compound is configured to envelop a substrate comprising:
a first substrate portion having first substrate surface and a first joint portion;
a second substrate portion having a second substrate surface and a second joint portion;
wherein the first joint portion and the second joint portion cooperate with each other to form a movable joint.

18. The molding device of claim 17, wherein the movable joint is a ball and socket joint, wherein the first joint portion is a ball portion and wherein the second joint portion is a socket portion.

19. The molding device of claim 17, wherein the first molding component and the second molding component are comprised of a non-porous rigid material.

20. The molding device of claim 17, wherein the first molding surface of the first molding component and the second molding surface of the second molding component cooperate with each other to form a molding cavity when the first molding component and the second molding component are secured to each other; and wherein the molding cavity is configured to receive the substrate enveloped by the modeling compound.
